(19) United States
(12) Patent Application Publication
(10) Pub. No.: US 2012/0007978 A1
(43) Pub. Date: Jan. 12, 2012

(54) Method and Apparatus For Examining A Semiconductor Wafer

(75) Inventors: Friedrich Passek, Adlkofen (DE); Juergen Fuchs, Burghausen (DE); Andreas Huber, Garching (DE); Friedrich Langenfeld, Kirchdorf (DE); Frank Laube, Burghausen (DE)

(73) Assignee: SILTRONIC AG, Munich (DE)

(21) Appl. No.: 13/163,932

(22) Filed: Jun. 20, 2011

(30) Foreign Application Priority Data
Jul. 7, 2010 (DE) 10 2010 026 351.6

(51) Int. Cl. G06K 9/00; H04N 7/18

(52) U.S. Cl. 348/87; 382/145; 348/E07.085

(57) ABSTRACT

The edges of semiconductor wafers are examined by an imaging method and the positions and forms of defects on the edge are determined, and in addition, a ring-shaped region on the flat area of the semiconductor wafer, the outer margin of which is ≦10 mm from the edge, is examined by means of photoelastic stress measurement and the positions of stressed regions in the ring-shaped region are determined, wherein the positions of the defects and the positions of the stressed regions are compared with one another, and the defects are classified in classes on the basis of their form and the results of the photoelastic stress measurement.

### CROSS-REFERENCE TO RELATED APPLICATION

This application claims priority to German Patent Application No. DE 10 2010 026 351.6 filed Jul. 7, 2010 which is herein incorporated by reference.

### BACKGROUND OF THE INVENTION

1. Field of the Invention

The invention relates to a method and an apparatus for examining a semiconductor wafer, wherein the edge of the semiconductor wafer is examined by means of an imaging method and the positions of defects on the edge are determined in this way.

2. Background Art

The quality requirements for the edges of semiconductor wafers, for example monocrystalline silicon wafers, are ever increasing, particularly in the case of large diameters (≧300 mm). In particular, it is intended for the edge to be as free as possible from contamination and other defects and to have a low roughness. Moreover, it is intended that the edges be resistant to increased mechanical stresses during transport and in process steps during the production of microelectronic components (e.g. coating and thermal steps). The untreated edge of a silicon wafer sliced from a single crystal has a comparatively rough and non-uniform surface. It often experiences spalling under mechanical loading and is a source of disturbing particles. Therefore, it is customary to regrind the edge in order thereby to eliminate spalling and damage in the crystal and to provide it with a specific profile.

Besides geometrical properties, defects at the wafer edge play an important part. The edge is repeatedly touched both during the production process and during transport. By way of example, the wafer edges come into contact with the cassettes used for storage or for transport. During the production process, the silicon wafers are moreover often removed from the cassette by means of edge grippers, supplied to a processing or measuring apparatus, and, after processing or measurement, transported back to the same or a different cassette by means of edge grippers again. Therefore, defects and impressions on the edge cannot be completely avoided. Some of these defects, such as, for example, cracks and spalling, can have the effect, for example, that the affected silicon wafers break in the course of further processing, particularly if additional stresses occur such as in the case of thermal processes or coatings in combination with mechanical treatments, which leads to considerable problems in the production line.

An examination of the wafer edge, at the latest prior to delivery to the customer, is absolutely necessary for this reason (also see HANDBOOK OF SEMICONDUCTOR SILICON TECHNOLOGY, ed. W. C. O'Mara, R. B. Herring, L. P. Hunt, William Andrew Publishing/Noyes, 1990). This examination serves, inter alia, for identifying and sorting out silicon wafers that are at risk of breaking on account of edge defects. At the present time, the edge monitoring is effected with the aid of visual or automatic inspection. Automatic inspection involves the use of imaging methods using cameras for the detection of the defects. The classification of the defects and the discrimination into noncritical and critical defects is effected by means of visual or automatic image analysis. Such a method for edge inspection is described in U.S. Pat. No. 7,576,849, for example.

The previously known methods of edge inspection do not always yield sufficient information about the nature of the defects detected. In particular, often it is not possible to identify whether a critical defect which can lead to the breaking of the semiconductor wafer is involved. This means that sorting of the silicon wafers is beset by a considerable uncertainty. Noncritical material can be incorrectly rejected and critical material can be delivered. The former factor decreases the yield unnecessarily, and the latter factor leads to problems for the customer.

### SUMMARY OF THE INVENTION

Therefore, an object of the present invention was to increase the meaningfulness of the edge inspection and, in particular, to enable an unambiguous classification of the detected edge defects with regard to increased risk of breaking. These and other objects are achieved by means of a method for examining a semiconductor wafer, wherein the edge of the semiconductor wafer is examined by means of an imaging method and the positions and forms of defects on the edge are determined thereby, wherein, in addition, a ring-shaped region on the flat area of the semiconductor wafer, the outer margin of which region is not more distant than 10 mm from the edge, is examined by means of photoelastic stress measurement, and the positions of stressed regions in the ring-shaped region are determined, wherein the positions of the defects and the positions of the stressed regions are compared with one another, and the defects are classified in classes on the basis of their form and the results of the photoelastic stress measurement.

### BRIEF DESCRIPTION OF THE DRAWINGS

FIG. 1 schematically shows a measuring arrangement that can be used for carrying out the method according to the invention.

FIGS. 2-9 show examples of defects which could not be classified unambiguously as critical or noncritical edge defects by means of the edge inspection method in accordance with the prior art. Together with the likewise illustrated results of the photoelastic stress measurement, the defects can be classified unambiguously according to the invention.

### DETAILED DESCRIPTION OF THE PREFERRED EMBODIMENTS

In contrast to the known methods for the detection and classification of edge defects, the method of the invention does not just use an imaging method, but rather combines the latter with data from a photoelastic stress measurement, i.e. with information about stressed regions in the material, in order to unambiguously identify edge defects that are critical with respect to breakage.

The imaging methods used can be optical imaging methods (using one or more cameras), electron-optical methods or atomic force microscopy (AFM).

Optical imaging methods examine the wafer edge by means of bright field or dark field optics or the combination of both. Typically, the wafer surface is examined on the front and rear sides in a region from the outermost margin of the wafer to approximately 5 mm inward, such that a sufficiently large overlap with the much more sensitive methods of front and rear side inspection arises in the edge region. The illumination of the wafer edge in bright field or dark field configuration typically takes place by means of LED, laser or other illumination sources at one frequency or with a broad frequency spectrum. At least one camera records images of the wafer margin including the edge region. A plurality of cameras are preferably used, which record the wafer margin and the edge from different perspectives.

The images serve as a basis for defect identification. The latter can be effected visually. Preferably, however, the image information is supplied for automatic classification by means of image processing software which can perform a classification into different configurable defect classes. Such an automatic classification is described in U.S. Pat. No. 7,576,849, for example, which is incorporated herein by reference. A sensitivity of approximately <10 μm LSE, verified by PSL (polystyrene latex spheres) on the wafer edge, is necessary in order to be able to resolve structures of critical defects.

This method is used in the present invention in the same way as the alternatives mentioned above are used in accordance with the prior art for identifying edge defects. According to the invention, however, it is combined with a photoelastic stress measurement, that is to say with the detection of stresses with the aid of depolarization effects. This method is known by the name “Scanning Infrared Depolarization” (SIRD) and described in US2004/0021097A1, for example, which is incorporated herein by reference. In accordance with the prior art, it is used for the sampling-like, whole-area detection of stressed regions on silicon wafers. An inspection of 100% of all silicon wafers in production is not practicable in the case of a whole-area measurement on account of long measurement times. The method has not been used hitherto to qualify the silicon wafers specifically with regard to the edge.

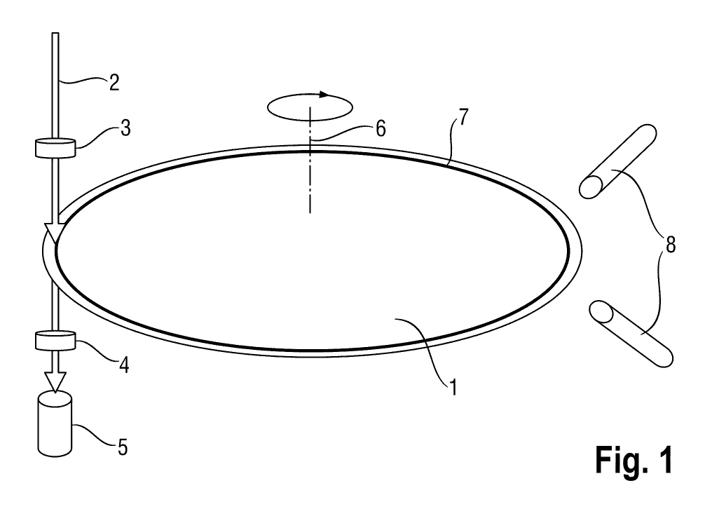

As illustrated in FIG. 1, in the application according to the invention, rather than the entire flat area of the semiconductor wafer 1 being examined by means of SIRD, only a ring-shaped region of the flat wafer area which lies close to the wafer edge is examined. In this case, the ring-shaped region is irradiated with an infrared laser beam 2 polarized by means of a polarizer 3. Preferably, the laser beam impinges perpendicularly on the flat area of the semiconductor wafer. After passing through the semiconductor wafer 1, the laser beam 2 passes through an analyzer 4. Downstream of the analyzer 4, the intensity and the degree of depolarization of the IR laser beam are measured and recorded by means of a detector 5. If the laser beam 2 passes through a stressed region in the semiconductor wafer 1, then this brings about a rotation of the polarization. In addition or as an alternative to the transmitted laser beam, by means of a correspondingly adapted arrangement it is also possible to use the reflected beam for the measurement.

In this description, “edge” or “wafer edge” is understood to mean the non-flat region, provided with a defined profile, at the margin of the semiconductor wafer. The surface of the semiconductor wafer thus consists of the flat areas of the front side and the rear side and also of the edge, which, for its part can comprise a facet on the front side and the rear side, a cylindrical web between the front side and the rear side and also transition radii between the respective facet and the web.

The ring-shaped region which lies close to the wafer edge preferably has a width of no more than 10 mm, more preferably not more than 3 mm. The width of the region is downwardly limited only by the diameter of the laser beam. The infrared laser beam can have a diameter of 20 μm to 5 mm.

The outer margin of the ring-shaped region is not more distant than 10 mm, and preferably not more distant than 5 mm, from the edge in order to always detect the stressed regions produced by the edge defects. Preferably, the ring-shaped region used for the SIRD measurement extends radially inward from the radial position at which the front side facet meets the flat area of the front side. This region directly adjoining the edge is to be preferred for the photoelastic stress measurement, although other regions which are near the edge but do not directly border on the edge can also be used for the measurement. It is also possible for the laser beam to overlap the edge. This is not preferred, however, since the overlapping portion is not utilized and, moreover, can generate inference signals.

The stressed regions caused by edge defects can extend on the flat area of the semiconductor wafer from the edge radially as far as 10 mm in the direction of the center of the semiconductor wafer. Only in the case of very severely stressed defects is it possible for the stressed regions to extend further into the flat area. This limits the position and width of the region to be examined by means of SIRD according to the invention. Since the stressed regions caused by edge defects are most greatly pronounced in direct proximity to the edge, the outer margin of the ring-shaped region to be examined is not more distant than 10 mm, and preferably not more distant than 5 mm, from the edge. Most preferably, the ring-shaped region borders directly on the edge. The width of the ring-shaped region to be examined by means of SIRD is therefore a maximum of 10 mm, a width of 3 mm or less likewise being sufficient.

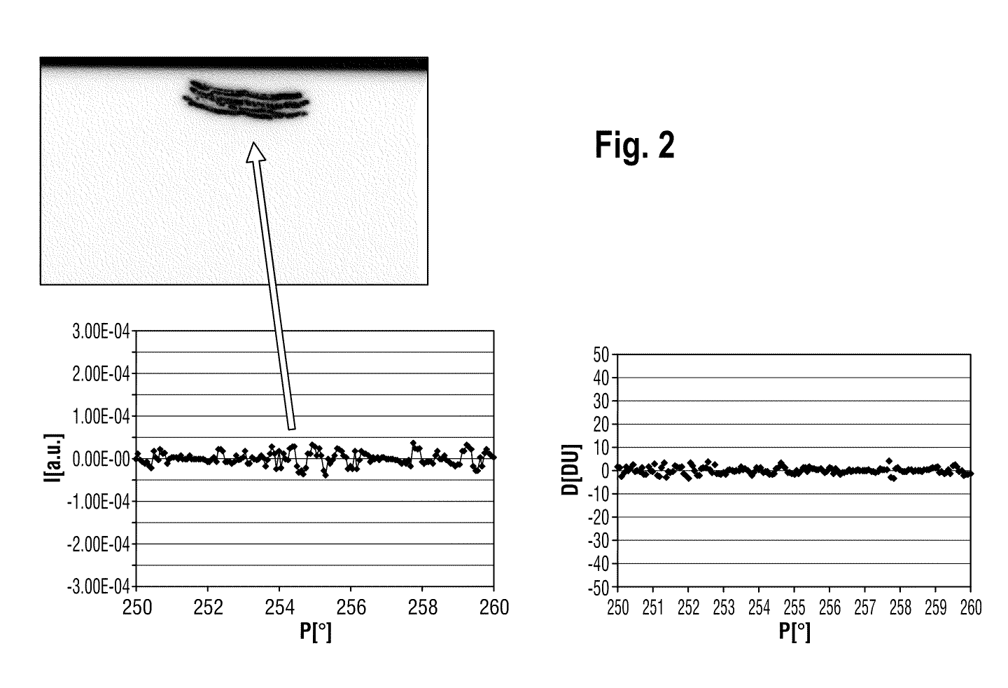

An extensive area signal is not required for the application of the SIRD method according to the invention. A small number of measurement tracks 7 (see FIG. 1) of the infrared laser beam 2 in the vicinity of the wafer edge (as defined above) are sufficient for this application. In particular, one to five measurement tracks are sufficient in order to obtain meaningful results with regard to the classification of edge defects. One to two measurement tracks are particularly preferred. The data shown in FIGS. 2 to 9 are based on a single measurement track.

The intensity of the laser beam and the integration time of the detection should be coordinated with one another such that a signal-to-noise ratio S/R>3 is ensured. The so-called lock-in technique is typically used in order to obtain good S/R values. Such techniques are well known in the field of signal processing.

The results of the imaging method and of the SIRD measurement are subsequently correlated with one another. This is illustrated by way of example in FIGS. 2 to 9. This correlation can be carried out in various ways, as indicated below.

It is appropriate to specify the position P of the defects identified by means of the imaging method and of the stressed regions identified by means of SIRD as an angle (in °), where the orientation feature (“notch” or “flat”) can serve as a reference point.

It is possible to use the results of the photoelastic stress measurement or those of the imaging method for the preselection of the defects. This means that only the defects which can be detected by one method are treated as defects and classified more specifically with the aid of the combined analysis of the results of both measurement methods.

Preference should be given, however, to working without preselection since positions which are identified as conspicuous only by the imaging method or the stress measurement, but not by the respective other method, can also include critical defects. Only a corresponding combined data analysis of both measurement methods ensures a best possible defect classification.

A preferred evaluation and classification method is described in detail below with reference to FIGS. 2-9:

In the first step, a first provisional defect classification is carried out on the basis of the data of the imaging method. Elongate (line-, crack- and scratch-like) structures can thus be differentiated from areal (spots, clusters) structures on the basis of the imaging method.

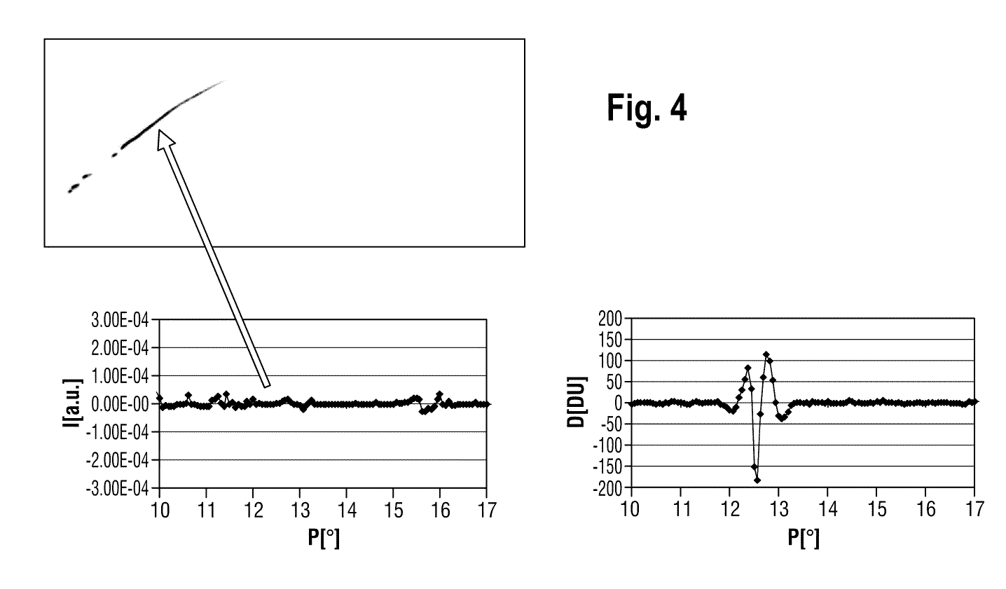

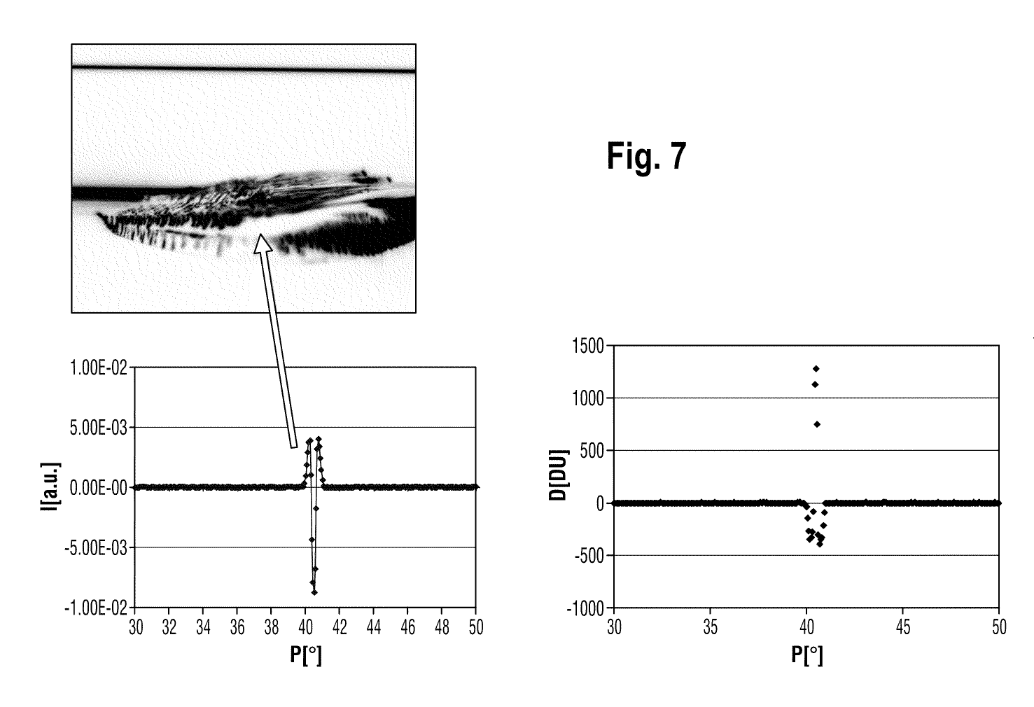

For the final classification, specific threshold values of the measurement variables of the photoelastic stress measurement are assigned to the provisional defect classes. Accordingly, the defects assigned to the provisional defect classes are finally classified by means of the results of the photoelastic stress measurement. If the imaging method classifies one defect as an elongate structure (e.g. FIG. 4) and another defect as an areal structure (e.g. FIG. 7), then e.g. the threshold values defined for the further classification can differ with regard to the evaluated measurement results of the SIRD measurement.

For the final defect classification based on the data of the photoelastic stress measurement, the following measurement variables can be used:

a) signal magnitude I (intensity)

b) signal profile

c) signal area

d) degree of depolarization D

e) depolarization signal type (unipolar or bipolar stress signal)

f) bipolarity B

All variables are preferably recorded and evaluated as a function of the angular position P (in °) at the margin of the measurement object.

The measurement variables used for the classification can be either absolute values above an averaged or subtracted background or average value, usually fixed as zero value, in a defect-free region (e.g. in the case of the intensity) or relative values such as e.g. in the case of the bipolarity B.

The degree of depolarization D is defined as follows:

D=1−(Iₚₐᵣ−Iₚₑᵣₚ)/(Iₚₐᵣ+Iₚₑᵣₚ)

I denotes the intensity of the detected laser light. Iₚₐᵣ and Iₚₑᵣₚ are the intensities polarized parallel and perpendicular, respectively, to the polarization direction predefined by the polarizer. D is measured in depolarization units DU (1 DU=1·10⁻⁶)

The bipolarity B is defined as follows:

B=1−|(Dₘₐₓ−|Dₘᵢₙ|)|/(Dₘₐₓ+|Dₘᵢₙ|)

D denotes the degree of depolarization, Dₘₐₓ denotes the maximum degree of depolarization, and Dₘᵢₙ denotes the minimum degree of depolarization. “∥” denotes the absolute value function.

Further variables (e.g. intensity variation/depolarization signal) derived from the measurement variables mentioned above can likewise be used for the final defect classification.

Alongside the data of the imaging method and of the photoelastic stress measurement, further information can be taken into account in the final defect classification. By way of example, it is possible to take account of the positions at which an increased risk of damage to the wafer edge appears in the production process for the silicon wafers, for example the positions at which the silicon wafers are exposed to particular mechanical stresses in the course of their production. The rules of the defect classification (e.g. threshold values of the measurement variables of the photoelastic stress measurement) can be specifically adapted at such positions.

The following table shows an exemplary matrix for the defect classification:

TABLE 1

| | | | Degree of | | |
|---|---|---|---|---|---|
| | Provisional classification | Intensity I | depolarization D | | |
| Classification | (imaging method) | [a.u.] | [DU] | Bipolarity B | Further criteria |
| Class A | Line-, crack-, scratch-like | <0.5 · 10⁻⁴ | >100 | >0.5 | |
| (crack/scratch) | | | | | |
| Class B | Areal and cluster structures | >1.0 · 10⁻⁴ | >100 | >0.35 | |
| (spalling) | | | | | |
| Class C | No image information | >0.5 · 10⁻⁴ | >15 | | |
| (contamination, | | | | | |
| noncritical stress) | | | | | |
| Class D | Area and cluster structures | <1.0 · 10⁻⁴ | >15 and <100 | >0.35 | Position coincides with |
| (process-induced | | | | | contact points in the |
| noncritical events) | | | | | production process |
| Class E | Elongate, areal and cluster | <1.0 · 10⁻⁴ | <15 | | |
| (contamination) | structures | | | | |
| Class F | | | | | |
| (miscellaneous) | | | | | |

It goes without saying that more detailed or other subdivisions into defect classes are possible; by way of example, in the case of Class C, it is possible to differentiate according to the SIRD signal strength or for the bipolarity additionally to be used as a criterion.

The assignment to these defect classes is explained below by way of example with reference to FIGS. 2 to 9. Each of the figures shows, in addition to the defect image (top) obtained by means of a camera, at the bottom left the intensity I (in “arbitrary units”, “a.u.”, since the intensity is dependent on the measuring instrument and the settings chosen) and at the bottom right the depolarization D (in DU), in each case as a function of the position P (in degrees) for the defect illustrated in the upper region of the figure.

FIG. 2: the defect image cannot be classified unambiguously. It is not clear whether scratches/cracks or residues are involved. SIRD shows that no critical stress (depolarization) of the crystal lattice is present. Together with the small SIRD intensity fluctuation, this allows contamination (Class E) to be deduced.

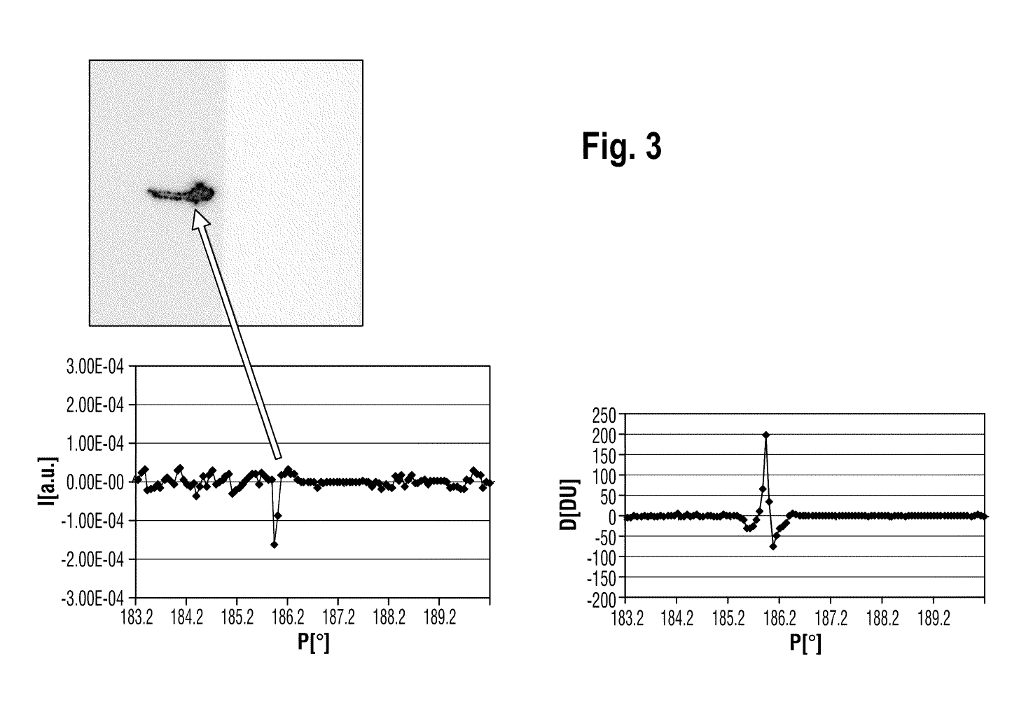

FIG. 3: the defect image cannot be classified unambiguously (cf. FIG. 2). SIRD shows a significant depolarization, and the likewise significant variation in the intensity proves that the transmission of the light has likewise been severely disturbed. The bipolarity of the SIRD signal unambiguously indicates stresses. The defect can therefore be classified as crack- or spalling-like material damage (Class B).

FIG. 4: the image does not reveal whether contamination, a scratch or a crack is involved. A high, unambiguously bipolar SIRD signal and almost no intensity variations in the transmission identify the structure unambiguously as a critical crack (Class A).

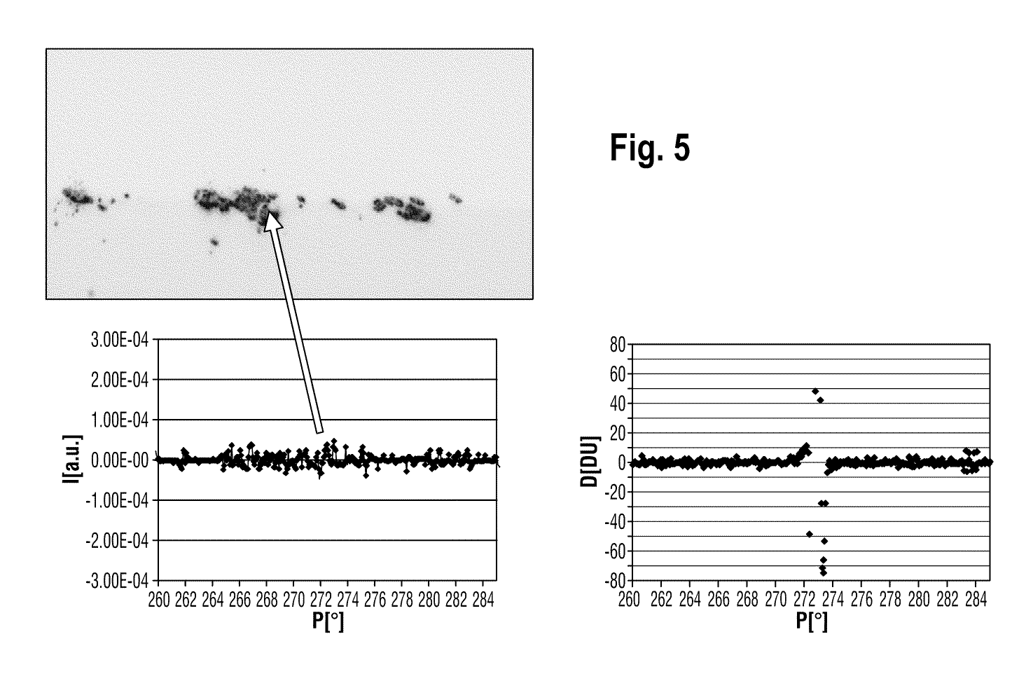

FIG. 5: the image does not permit unambiguous identification of the defect. The SIRD data show a high, bipolar depolarization. Together with the variation of the SIRD intensity and knowledge of the process history (an epitaxially coated silicon wafer is involved), the defect can be identified as an accumulation of epitaxial growths (Class D).

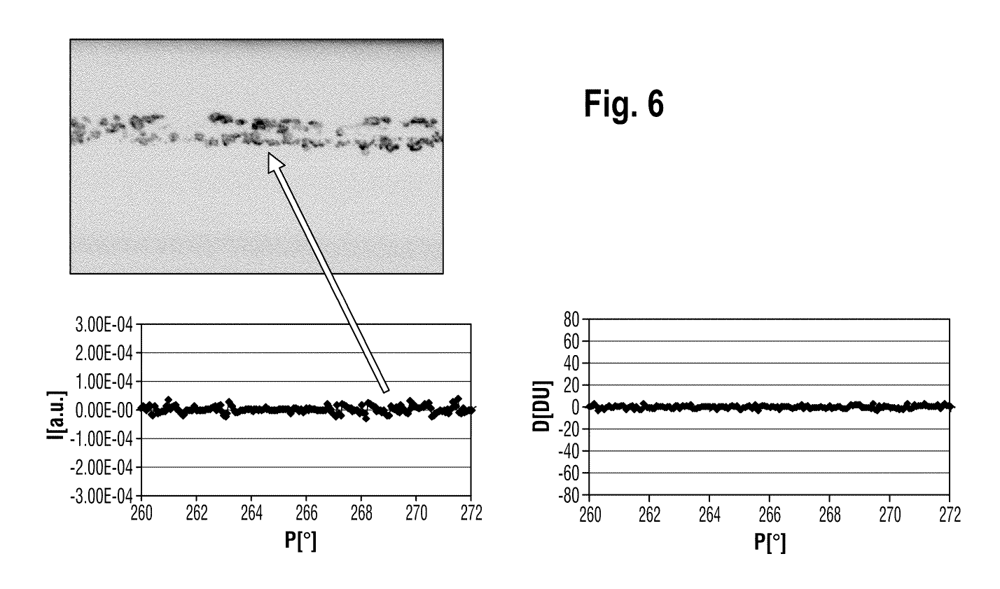

FIG. 6: the image is comparable with that from FIG. 5. The inconspicuous SIRD data prove unambiguously, however, that contamination (Class E) is involved here.

FIG. 7: both high stress signals and intensity variations can be observed in the SIRD measurement. Together with a bipolarity B>0.35 and with the area information of the camera image, this identifies the defect as spalling (Class B).

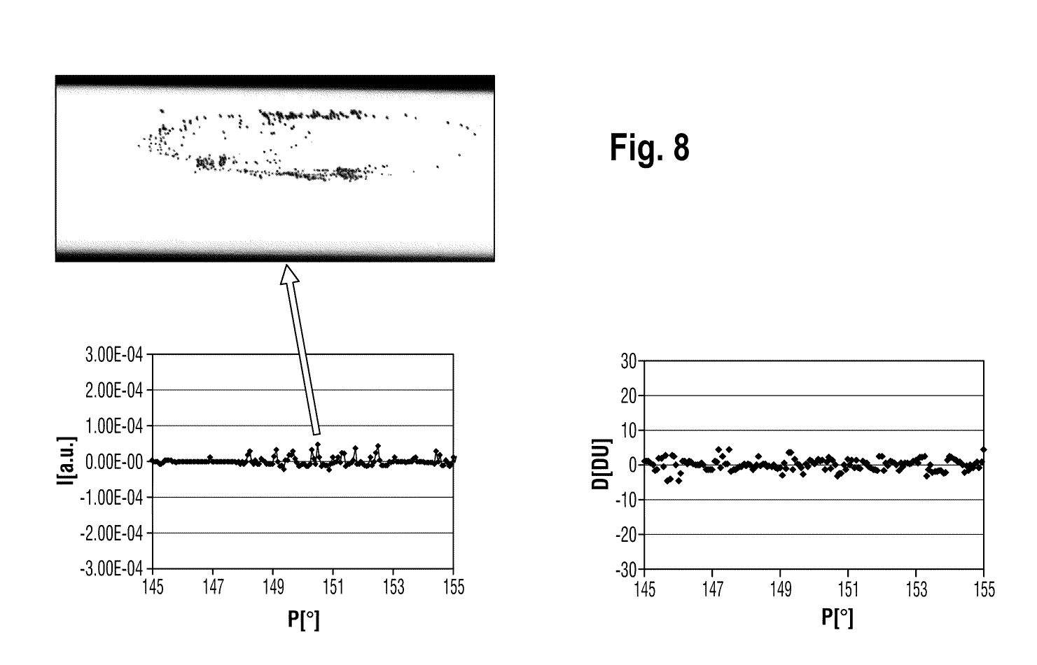

FIG. 8: image and SIRD data identify the defect unambiguously as contamination (Class E): no depolarization, slight SIRD intensity signals.

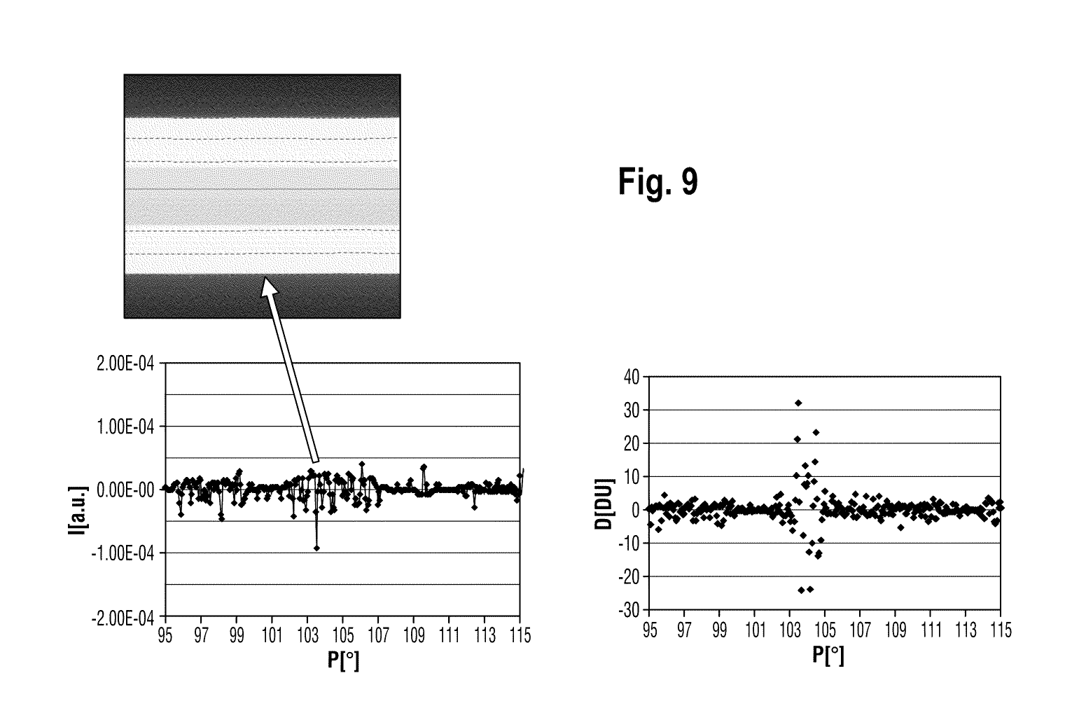

FIG. 9: the absence of structures in the camera image proves that massive damage is not present. SIRD, by contrast, simultaneously shows slight intensity and depolarization signals. The depolarization signal exhibits high fluctuations, but no classic bipolarity. The cause of the SIRD signal is therefore assumed to be contamination transparent to the camera (Class F).

The method according to the invention is thus able, for example, to avoid misinterpretations in the case of cracks. Cracks often cannot be differentiated from other elongate structures solely by means of imaging methods. Examples of this are shown in FIGS. 2 and 4.

The combination according to the invention of the imaging method with a method for identifying stresses thus enables a significantly more reliable defect classification particularly with regard to defects that are critical in respect of breaking.

In accordance with the defect classification performed, the relevant silicon wafers can be allocated to rework, further use or rejects.

The two measurements which are used according to the invention for examining the edge of a semiconductor wafer can be carried out successively with the aid of the known apparatuses. By way of example, an edge inspection apparatus of the type described in U.S. Pat. No. 7,576,849 and an SIRD measuring instrument of the type described in US2004/0021097A1 can be used. A particularly short measurement time can be obtained, however, if both measurement methods are carried out simultaneously at different locations of a semiconductor wafer 1 rotating about its central axis 6 (see FIG. 1). One or more, preferably at least two, cameras 8 for the imaging edge inspection method are installed at one location (illustrated on the right in FIG. 1). The SIRD measurement is carried out at another location (illustrated on the left in FIG. 1). The rotation of the semiconductor wafer 1 about its central axis 6 has the effect that the entire circumference of the wafer edge is moved past the cameras 8 and the arrangement for the SIRD measurement method, such that the entire length of the revolving edge can be examined by means of both methods. The relative speed of the wafer edge with respect to the detectors both of the imaging method and of the photoelastic stress measurement should be between 2 and 30 cm/s in order to ensure a sufficient integration time for both measurement methods. Besides carrying out the SIRD measurement and the imaging method simultaneously, it is also possible, of course, for the methods to be performed non-simultaneously with the aid of this apparatus, although this should not be preferred on account of longer measurement times.

In order to realize the one to five measurement tracks specified above as preferred, it is merely necessary to ensure that the semiconductor wafer performs a corresponding number of rotations. In this case, the position of the measuring device for the photoelastic stress measurement can remain unchanged during a rotation and be altered after each rotation in a radial direction with respect to the semiconductor wafer in such a way that the circular measurement tracks lie at different radial positions within the defined region on the semiconductor wafer during each rotation. On the other hand, the position of the measuring device for the photoelastic stress measurement can be altered continuously in a radial direction with respect to the semiconductor wafer in such a way that the infrared laser beam used for the photoelastic stress measurement describes a spiral or “undulating” measurement track within the ring-shaped region. A fixed position and a single measurement track are preferred. With a small number of measurement tracks, the laser beam can also be controlled by means of electro-optical deflection and its position on the test specimen can thus be altered.

Simultaneously carrying out the imaging method and the SIRD measurement method makes it possible for the measurement time required for the edge inspection to be kept unchanged despite a gain of additional information. A measurement time of less than one minute can thus be achieved for the entire edge inspection including SIRD.

For carrying out the method described above it is possible to use an apparatus comprising the following constituent parts:

a mount for the semiconductor wafer 1, which can be rotated about its central axis 6,

a drive for causing the mount to rotate,

a system for carrying out an imaging method comprising at least one light source and one camera 8 that records images of the edge of the semiconductor wafer 1, and

a system for carrying out a photoelastic stress measurement comprising a laser, a polarizer 3, an analyzer 4 and a detector 5 in an arrangement that permits the examination of a region of the flat area in the vicinity of the edge of the semiconductor wafer.

The interaction of the individual constituent parts for carrying out the method has already been described above.

The method according to the invention can be used at any desired point in the context of the production of semiconductor wafers, in particular of monocrystalline silicon wafers. However, it is preferably used after the conclusion of the edge processing, that is to say after edge rounding and edge polishing have been effected. Application to the fully completed, non-patterned semiconductor wafer is particularly preferred. It is also preferred, in particular, to examine not just samples but all of the semiconductor wafers by means of the method according to the invention before they are delivered to the customer. The method according to the invention makes it possible to reliably pick out semiconductor wafers that are at risk of breaking on account of edge defects. However, the method also makes it possible to identify the cause of the defects and to eliminate the latter.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for examining a semiconductor wafer, comprising examining an edge of the semiconductor wafer by an imaging method and determining the positions and forms of defects on the edge, and in addition, examining a ring-shaped region on the flat area of the semiconductor wafer, the outer margin of which is not more distant than 10 mm from the wafer edge, by means of photoelastic stress measurement and determining the positions of stressed regions in the ring-shaped region, wherein the positions of the defects and the positions of the stressed regions are compared with one another, and the defects are classified in classes on the basis of their form and the results of the photoelastic stress measurement.

2. The method of claim 1, wherein the imaging method comprises illuminating the edge being examined and recording images of the edge with at least one camera.

3. The method of claim 1, wherein the ring-shaped region has a width of not more than 5 mm.

4. The method of claim 2, wherein the ring-shaped region has a width of not more than 5 mm.

5. The method of claim 1, wherein at least one of the following variables a) through f) which are obtained from the photoelastic stress measurement
a) signal magnitude
b) signal profile
c) signal area
d) degree of depolarization
e) depolarization signal type and
f) bipolarity
is used for classifying the defects into classes.

6. The method of claim 2, wherein at least one of the following variables a) through f) which are obtained from the photoelastic stress measurement
a) signal magnitude
b) signal profile
c) signal area
d) degree of depolarization
e) depolarization signal type and
f) bipolarity
is used for classifying the defects into classes.

7. The method of claim 1, wherein the semiconductor wafer rotates about its central axis, wherein measuring devices for the imaging method and the photoelastic stress measurement are positioned at different positions along the circumference of the semiconductor wafer, and the semiconductor wafer is examined simultaneously by means of the imaging method and by means of the photoelastic stress measurement, wherein the entire circumference of the edge and the adjoining region are moved past the measuring devices for the imaging method and the photoelastic stress measurement by rotating the semiconductor wafer.

8. The method of claim 7, wherein the semiconductor wafer rotates one to five times about its central axis.

9. The method of claim 8, wherein an infrared laser beam is used for the photoelastic stress measurement, and describes a circular measurement track within the ring-shaped region during each rotation of the wafer, and wherein the position of the measuring device for the photoelastic stress measurement is altered after each rotation in a radial direction with respect to the semiconductor wafer in such a way that the measurement tracks lie at different radial positions on the semiconductor wafer.

10. The method of claim 8, wherein the position of the measuring device for the photoelastic stress measurement is altered continuously in a radial direction with respect to the semiconductor wafer in such a way that the infrared laser beam used for the photoelastic stress measurement describes a spiral measurement track within the ring-shaped region.

11. The method of claim 8, wherein the speed of the edge of the rotating semiconductor wafer is between 2 and 30 cm/s.

12. An apparatus for examining the edge of a semiconductor wafer, comprising:
a) a mount for the semiconductor wafer which is rotatable about a central axis,
b) a drive for rotating the mount,
c) an imaging system comprising at least one light source and at least one camera that records images of the edge of the semiconductor wafer, and
d) a photoelastic stress measurement system comprising a laser, a polarizer, an analyzer and a detector which permits the examination of stress in a region of the flat area in the vicinity of the edge of the semiconductor wafer.
